(19) United States
(12) Patent Application Publication
(10) Pub. No.: US 2026/0277897 A1
(43) Pub. Date: Sep. 17, 2026

(54) Recognition-Based Database Search Algorithm (RDSA): Accelerated Query Optimization and Data Retrieval Using Recognition Coverage Functions

(71) Applicant: Jonathan Washburn, Austin, TX (US)

(72) Inventor: Jonathan Washburn, Austin, TX (US)

(21) Appl. No.: 19/563,793

(22) Filed: Mar. 11, 2026

Related U.S. Application Data
(60) Provisional application No. 63/770,741, filed on Mar. 12, 2025.

(51) Int. Cl. G06F 16/2453

(52) U.S. Cl. CPC G06F 16/24542

(57) ABSTRACT

A recognition-based database search algorithm accelerates database queries and optimizes data retrieval by applying a bounded recognition coverage function with a fixed constant across query analysis, data-structure sizing, plan selection, and resource allocation. A query is received and parsed to derive nonnegative query feature magnitudes, and a complexity score is computed by applying the coverage function to the magnitudes. One or more database access structures are configured using recognition-based parameters, including a tree index node capacity, a hash-table bucket count and key mapping, and a probabilistic membership filter size and hash count. Candidate execution plans are scored using a coverage-weighted combination of inverse cost and resource feasibility, and a selected plan is executed using recognition-weighted resource allocations among concurrent tasks. Runtime telemetry can trigger adaptation of sizing, partitioning, and scheduling without changing the fixed constant. The techniques are applicable to relational, NoSQL, in-memory, time-series, and distributed database systems.

### CROSS-REFERENCE TO RELATED APPLICATIONS

This application claims the benefit of U.S. Provisional Patent Application No. 63/770,741, filed Mar. 12, 2025, titled “Recognition-Based Database Search Algorithm (RDSA): A System for Accelerating Database Queries and Optimizing Data Retrieval Using Recognition Physics Principles.”

### BACKGROUND

Database systems and database management systems are used to store and retrieve large volumes of data in response to queries, including queries expressed in SQL, NoSQL query formats, and application programming interface calls. Query execution typically relies on a combination of indexing structures, query optimization, and resource scheduling to select an execution strategy and to allocate compute, memory, and I/O resources during execution. As dataset sizes and workloads scale, conventional approaches often require extensive manual tuning of index parameters, planner cost model parameters, and resource management policies, and such tuning can be workload-specific and sensitive to changes in data distribution, cardinality, and concurrency.

Conventional query optimization and indexing techniques can also exhibit inefficiencies under dynamic conditions, including tail latency increases under contention, increased I/O amplification when selectivity is misestimated, and performance degradation when index structures or probabilistic filters are over-sized or under-sized relative to the true working set. Distributed deployments introduce additional challenges, including cross-node fan-out, hot-spot partitions, and shifting availability of resources across nodes and shards. Accordingly, there is a need for improved techniques that accelerate database queries and optimize data retrieval by providing stable, bounded mechanisms for scoring, sizing, plan selection, and resource allocation that adapt to workload change while reducing reliance on empirically tuned parameters.

### SUMMARY

In one aspect, a database query optimization and execution system accelerates database queries and optimizes data retrieval by applying a bounded recognition coverage function having a fixed constant to multiple stages of query processing. The system receives a query, parses and analyzes the query to derive nonnegative query feature magnitudes, computes a complexity score by applying the recognition coverage function to the feature magnitudes, and computes recognition-based configuration parameters for one or more database access structures. The system generates candidate execution plans, computes plan scores that incorporate both a cost estimate and a feasibility ratio derived from available and required computing resources, selects an execution plan using the plan scores, allocates computing resources among concurrent tasks using allocation weights derived from the recognition coverage function and nonnegative demand magnitudes, and executes the selected plan to output query results. Because the recognition coverage function is bounded and saturating, the resulting sizing, scoring, and allocation behaviors remain stable across small and large regimes without empirically tuning the fixed constant.

In another aspect, the system configures and maintains recognition-optimized data structures, plan selection policies, and resource allocation behaviors as cooperating stages of a single end-to-end query execution pipeline that uses the bounded recognition coverage function as a shared normalization primitive. In representative embodiments, the system computes a recognition-based node capacity for a tree-based index, a recognition-based bucket count and key mapping for a hash structure, and recognition-based sizing parameters for a probabilistic membership filter, and may use a multi-dimensional recognition array to constrain candidate plan generation and execution for multi-attribute queries. In distributed deployments, the system may perform recognition-informed routing, partition management, and recognition-weighted resource allocation based on runtime telemetry. By normalizing multiple database-control magnitudes (including feature magnitudes, sizing inputs, and feasibility ratios) under a bounded and saturating function, the disclosed techniques reduce I/O amplification associated with misestimation, mitigate hot-spot partitions and cross-node fan-out, and stabilize tail latency under contention without empirically tuning the fixed constant. These aspects may be implemented as a computer-implemented method, a database system including one or more processors and memory, and a non-transitory computer-readable medium storing instructions that cause performance of the described operations.

### BRIEF DESCRIPTION OF THE DRAWINGS

The various advantages of the examples will become apparent to one skilled in the art by reading the following specification and appended claims, and by referencing the following drawings, in which:

FIG. 1 is a block diagram of an example system architecture for executing a recognition-based database search algorithm, including query ingestion, query analysis, recognition-based scoring and sizing, execution planning, resource allocation, and query execution to produce results.

FIG. 2 is a diagram illustrating an example recognition coverage function and associated behaviors, including boundedness, monotonicity, and saturation, and showing how a fixed constant is used as part of the function definition.

FIG. 3 is a diagram illustrating an example recognition-optimized tree-based index structure and associated sizing, including an example node-capacity determination and example structural behaviors related to maintaining the index.

FIG. 4 is a diagram illustrating an example recognition-optimized hash structure and associated sizing and key mapping, including an example bucket-count determination and an example recognition-weighted hashing approach.

FIG. 5 is a diagram illustrating an example recognition-optimized probabilistic membership filter and associated sizing and operation, including an example bit-vector sizing, an example hash-count determination, and example insert and query flows.

FIG. 6 is a diagram illustrating an example recognition-weighted resource allocation process for allocating a resource budget among concurrent tasks based on demand magnitudes and bounded coverage weights.

FIG. 7 is a diagram illustrating an example execution-path scoring and selection process for selecting among candidate execution plans using plan costs and resource feasibility.

FIG. 8 is a flowchart illustrating an example end-to-end method for recognition-based query processing, including receiving a query, analyzing the query, computing recognition-based scores and sizing parameters, selecting an execution plan, allocating resources, executing the plan, and monitoring and adapting based on runtime telemetry.

FIG. 9 is a diagram illustrating an example computing environment in which the disclosed methods and systems may be implemented using one or more processors, memory, storage, and network interfaces in association with database management software.

FIG. 10 is a diagram illustrating an example distributed deployment in which the disclosed methods and systems operate across a cluster including multiple database nodes, partitions or shards, routing, telemetry aggregation, and per-node resource allocation.

### DETAILED DESCRIPTION

All mathematical expressions in this specification are written in plain-text using ASCII-safe notation to preserve copy/paste integrity and to avoid ambiguity across document editors, fonts, and export formats. Unless expressly stated otherwise, variables and functions are defined over real numbers, with nonnegativity constraints stated where applicable. The following conventions apply throughout.

The symbol “phi” denotes the golden ratio, defined as:

phi=(1+sqrt(5))/2

The symbol “pi” denotes the mathematical constant pi, representing the ratio of a circle's circumference to its diameter. Where a numerical approximation is helpful for implementation, pi may be treated as a standard library constant.

The recognition constant used by the recognition coverage function is written as “X_opt” and is defined as:

X_opt=phi/pi

X_opt is treated as a fixed constant. Operational configuration targets (e.g., false-positive rate “epsilon”, resource budgets, or service-level thresholds) are inputs to computations but do not alter the value of X_opt.

The base-2 logarithm is written as:

log 2(x)

In implementations lacking a native log 2 function, log 2(x) may be computed using a natural logarithm or base-10 logarithm as:

log 2(x)=log(x)/log(2)

where “log” is any logarithm function with a consistent base. Unless stated otherwise, the domain constraints for logarithms apply (e.g., x>0).

The ceiling function is written as:

ceil(x)

and denotes the smallest integer greater than or equal to x. The ceiling function is used to convert a real-valued sizing expression into an implementable integer parameter (e.g., an integer number of buckets, bits, or node slots). Where a minimum valid integer size is required by the hosting data structure, implementations may additionally enforce a floor such as “max(1, ceil(x))” or “max(2, ceil(x))” as appropriate to the specific structure's invariants.

Products across an index set are written using “prod” notation in ASCII as:

prod_i( . . . )

For example, a product over i=1 . . . n may be written as:

prod_{i=1 . . . n}f(i)

When a shorter form is used, the index range is stated in the accompanying text. If n=0 arises in any implementation context, the empty product may be treated as 1, unless explicitly overridden by an embodiment that requires at least one factor.

Summations across an index set are written as:

sum_j( . . . )

For example:

sum_{j=1 . . . m}g(j)

As with products, the index range is stated in the accompanying text.

Equality, inequality, and interval notation are expressed using standard ASCII operators. For example:
nonnegativity: r>=0
positivity: cost>0
closed/open intervals: [0, 1), (0, 1)

Greek letters are avoided in equations in favor of ASCII variable names. For example, the false-positive target is written as “epsilon” (not ε), and all other parameters that might otherwise be represented with Greek symbols are spelled out in ASCII.

When an equation includes a function name (e.g., F_cov), the function name is treated as a literal identifier and not as an implied multiplication of characters. Implementations may map these identifiers to function names in code, provided the mapping preserves the defined inputs, outputs, and domain constraints.

To avoid confusion between numerals and ordinary numbers in the prose, reference numerals for drawing elements are introduced later in the specification and are not used in this conventions section.

Definitions are provided below to clarify terminology used throughout this specification and in the claims. Unless otherwise stated, each definition applies to all embodiments described herein.

“Recognition coverage function” or “RCF” means a real-valued function that maps a nonnegative input magnitude to a bounded coverage value and is used as a sizing or scoring factor in database operations. In representative implementations, the recognition coverage function is defined as F_cov(r, X_opt)=r/(r+X_opt) for r>=0, where X_opt is a fixed positive constant. The recognition coverage function is used as a universal normalization function to transform an input magnitude r into a coverage value in a bounded range.

“Recognition input” or “r” means a nonnegative scalar quantity provided as input to the recognition coverage function. Depending on context, r may represent, by way of non-limiting example, a record count, a cardinality estimate, a query feature magnitude, a resource demand magnitude, an inverse cost magnitude, an availability ratio magnitude, or any other nonnegative quantity used to drive sizing or selection decisions.

“Recognition constant” or “X_opt” means a fixed positive constant used by the recognition coverage function. X_opt is treated as parameter-free in the sense that it is not empirically tuned as a function of workload, dataset, or deployment environment. Operational configuration targets (for example, memory budgets, service-level targets, or a false-positive target for a filter) may vary between deployments, but do not modify X_opt.

“Coverage value” means the output of the recognition coverage function for a given recognition input. For the representative form F_cov(r, X_opt)=r/(r+X_opt), the coverage value increases as r increases and approaches a saturation behavior as r becomes large.

“Bounded coverage” means that the coverage value is constrained to a finite interval for all valid inputs. For the representative form above, bounded coverage means the output lies within [0, 1) for all r>=0.

“Monotone increasing” means that increasing the recognition input does not decrease the coverage value. For the representative form above, monotone increasing means that if r1<=r2 then F_cov(r1, X_opt)<=F_cov(r2, X_opt), for r1>=0 and r2>=0.

“Saturation behavior” means that for sufficiently large recognition input values, incremental increases in the recognition input yield diminishing incremental increases in the coverage value. Saturation behavior is used to prevent oversizing or overweighting driven purely by large scale.

“Database” means a collection of records stored in a data store and managed by a database management system. A database may be implemented in a relational database, a key-value store, a document store, a columnar store, a time-series store, a graph database, or a distributed database system.

“Database record” or “record” means a stored data item in a database. A record may correspond to a row, document, key-value entry, time-series sample, vertex, edge, or other storage unit depending on the database type.

“Record count” or “N” means a nonnegative integer or integer-valued estimate representing a number of records relevant to a sizing decision. N may represent, by way of non-limiting example, the number of records in a table, a partition, an index, a shard, a collection, or a working set.

“Query” means an instruction to retrieve, compute, filter, join, aggregate, traverse, or otherwise operate on database records. A query may be expressed in a query language (for example, SQL) or in an application programming interface call that is translated into a query plan by a database system.

“Query component” means a feature, operator, clause, predicate, join, aggregation, traversal step, grouping, filter, or other analyzable part of a query or a query plan that can be represented by a nonnegative scalar magnitude for scoring or sizing.

“Query feature scalar” or “q_i” means a nonnegative scalar derived from a query, a query plan, or workload telemetry that quantifies a magnitude of a query component. q_i is defined such that q_i>=0. Different embodiments may select different features for q_i, provided they are computed as nonnegative quantities and are used consistently when computing query complexity. In non-limiting examples, q_i values are computed from analyzable quantities that can be represented as counts, estimates, or indicator magnitudes, such as: (i) a join count magnitude (e.g., number of join operators), (ii) a predicate count magnitude (e.g., number of filter predicates), (iii) an aggregation indicator magnitude (e.g., 0 for no aggregation, 1 for aggregation present), (iv) a grouping magnitude (e.g., number of grouping keys), (v) an estimated cardinality magnitude (e.g., estimated output rows or intermediate rows), (vi) a range predicate indicator magnitude, and/or (vii) a traversal step magnitude for graph or hierarchical queries. In embodiments where a feature is naturally signed or may be negative, the feature is transformed into a nonnegative magnitude before use as q_i (for example, by absolute value, clamping at zero, or mapping to a nonnegative estimate), provided the transformation is applied consistently for scoring and sizing decisions.

“Complexity score” means a scalar score computed from one or more query feature scalars using the recognition coverage function. In representative implementations, a complexity score is computed as a product of recognition coverage function values applied to the query feature scalars. A complexity score may be used to drive plan selection, resource allocation, or selection of data structures.

“Recognition-optimized data structure” means a data structure whose sizing parameter is computed as a function of the recognition coverage function. In non-limiting embodiments, recognition-optimized data structures include a recognition B+ tree, a recognition hash table, and a recognition bloom filter, each having one or more sizing parameters derived using F_cov.

“Node capacity” means an integer parameter that limits or defines a maximum number of keys, entries, or pointers stored within a node of a tree-based index structure. Node capacity is used to determine node split and merge behavior and to influence the height and fan-out of the index.

“Bucket” means a container or slot in a hash table into which one or more keys map. A bucket may store entries directly or may store pointers to entries.

“Bucket count” means an integer parameter representing a number of buckets in a hash table. Bucket count is used to size a bucket array and to determine the modulus used when mapping hash outputs to bucket indices.

“Base hash function” means a deterministic function that maps a key to a numeric hash value for use in a hash table. A base hash function may be any hash function supported by a host database or application, provided the function is consistent for identical key inputs.

“Key” means an identifier used to locate or associate records, including, by way of non-limiting example, a primary key, a composite key, an index key, a document identifier, or a graph element identifier.

“Key magnitude” means a nonnegative scalar representation of a magnitude associated with a key. In non-limiting examples, key magnitude may be a key length in characters or bytes, a bit-length, a count of key fields, or another nonnegative measure of key complexity or size.

“Recognition hash function” means a hash mapping used in a recognition hash table that incorporates the recognition coverage function to influence the mapping between keys and bucket indices. A recognition hash function may be implemented as a transformation of a base hash output by a factor derived from F_cov applied to a key magnitude.

“Bloom filter” means a probabilistic membership data structure implemented using a bit vector and one or more hash functions to test whether an element is a member of a set, with a possibility of false positives and no false negatives under correct operation.

“Bit vector size” or “M” means an integer representing a number of bits in a bloom filter bit vector.

“Hash count” or “k” means an integer representing a number of hash functions or hash iterations applied for each insert and membership test in a bloom filter.

“False-positive target” or “epsilon” means a configured value representing a target probability of reporting set membership for an element that is not a member of the set. epsilon satisfies 0<epsilon <1.

“Candidate plan” or “candidate execution path” means a potential query execution strategy produced by a query planner. Candidate execution paths may differ by access method, join order, join algorithm, filter ordering, index usage, pre-filter usage, or distributed routing strategy.

“Cost” means a positive scalar estimate of expected resource consumption, latency, or execution time for a candidate execution path. A cost estimate may be produced by a query optimizer cost model or derived from historical telemetry. Cost satisfies cost >0.

“Available resources” or “available” means a nonnegative scalar representation of resources currently available for use by a candidate execution path, query, or task. Available may represent, by way of non-limiting example, available CPU capacity, memory, I/O bandwidth, network budget, thread slots, queue capacity, or a composite resource unit. available satisfies available >=0.

“Required resources” or “required” means a positive scalar representation of resources required to execute a candidate execution path within an intended performance level. required satisfies required >0.

“Path score” or “score” means a nonnegative scalar used to rank candidate execution paths. In representative implementations, a path score incorporates a recognition coverage function applied to an inverse cost and a recognition coverage function applied to an availability-to-requirement ratio.

“Task” means a unit of work that consumes resources in a database system. A task may correspond to a query, a query stage, a shard-level subquery, a pipeline operator, a background maintenance task, or another schedulable work unit.

“Demand” or “demand_i” means a nonnegative scalar representing resource demand of a task i. Demand may be derived from query complexity, estimated work size, queue backpressure, service-level targets, or observed runtime behavior. demand_i satisfies demand_i>=0.

“Resource budget” or “R” means a total amount of allocable resources available for distribution among tasks. R may represent a CPU budget, memory budget, I/O budget, network budget, or a composite budget in a normalized resource unit.

“Allocation” means a nonnegative scalar representing an amount or share of the resource budget assigned to a task. An allocation may be expressed as an absolute quantity or as a fraction of the resource budget.

“Machine-verified” means that a stated mathematical property is supported by a formal proof artifact checked by an automated proof checker. Machine-verified refers to the verification status of a stated property and does not require any particular runtime behavior in an implementation.

“Formal proof artifact” means a structured proof object, proof script, proof term, or other proof representation that is capable of being checked by a proof assistant or proof checker. In certain embodiments, formal proof artifacts are produced using the Lean 4 proof assistant, and are used to substantiate properties such as boundedness, monotonicity, positivity, or nonnegativity for the stated functions and sizing expressions.

The recognition coverage function is parameterized by a fixed, predetermined constant rather than a workload-tuned parameter. In particular, the constant X_opt (220) used by the recognition coverage function (200) is defined as a ratio of two mathematical constants, X_opt=phi/pi, where phi denotes the golden ratio and pi denotes the constant pi. In representative implementations, phi is defined as phi=(1+sqrt(5))/2, and phi is the unique positive solution to the algebraic identity phi\hat{ }2=phi+1. This uniqueness is relied upon only to justify that X_opt (220) is fixed by definition, rather than selected or calibrated by empirical fitting.

In this specification, “parameter-free” with respect to X_opt (220) means that X_opt is not adjusted based on the dataset, query workload, deployment environment, or measured performance outcomes. X_opt is treated as a constant input to the recognition coverage function (200) across use cases, including when the recognition input r (210) represents record count, cardinality, query-feature magnitudes, resource demands, inverse costs, or ratios derived from availability and requirements. Operational configuration values that may vary across deployments, such as an acceptable false-positive target epsilon for probabilistic filtering, service-level targets, or a resource budget, are treated as configuration inputs to computations and policies, and do not modify the fixed value of X_opt (220).

This fixed-constant posture is used to avoid manual tuning and to stabilize the behavior of recognition-based scaling across regimes. The coverage output F_cov(r, X_opt) (230) remains bounded and saturating for all nonnegative r (210), so that scaling decisions driven by very large magnitudes do not grow without bound. For example, boundedness behavior (240), monotonicity behavior (250), and saturation behavior (260) provide a consistent mapping from magnitude inputs to normalized coverage outputs. In some embodiments, formal verification artifacts (270) may be provided to substantiate one or more mathematical properties of the recognition coverage function (200) and its fixed-constant form, such as boundedness, monotonicity, and positivity under stated domain constraints.

Within the overall system, the fixed constant X_opt (220) is applied uniformly across the recognition coverage function engine (150) and the downstream optimization decisions that depend on it. In representative embodiments, the recognition coverage function engine (150) supplies coverage values to the recognition-optimized data structure manager (160) for sizing and maintenance, to the execution engine (170) for plan scoring and path selection, and to the resource allocator (180) for proportional allocation across concurrent tasks. Because X_opt (220) is not tuned per workload, these subsystems share a common normalization basis when computing sizing factors, scoring factors, and allocation weights from their respective nonnegative inputs.

The mathematical foundations described in this specification use the recognition coverage function (200) as a bounded, monotone scaling primitive that converts nonnegative magnitudes into normalized coverage values. In representative implementations, the recognition coverage function (200) is defined as F_cov(r, X_opt)=r/(r+X_opt) for r>=0, where r is a nonnegative recognition input (210) and X_opt is a fixed positive constant (220). The output coverage value (230) is bounded and saturating, which is used to stabilize sizing and scoring behaviors across small and large regimes of the underlying magnitude inputs. In this manner, sizing expressions and scoring expressions can be formed from a common normalization basis without requiring dataset-specific tuning of X_opt (220).

For query complexity scoring, a query analyzer and feature extractor (130) derives one or more nonnegative query feature scalars q_i from a received query and/or its intermediate plan representation. A complexity scorer (140) then computes a normalized complexity score using the recognition coverage function engine (150). In one embodiment, the complexity score is computed as a product across feature factors, for example:

ComplexityScore(Q)=prod_{i=1 . . . n}F_cov(q_i,X_opt)

where each q_i is computed such that q_i>=0. Because each factor F_cov(q_i, X_opt) lies within [0, 1) for q_i>=0, the resulting complexity score is normalized and bounded, which supports stable comparisons across diverse queries. In non-limiting examples, the query feature scalars q_i may encode magnitudes corresponding to counts of operators, estimated cardinalities, numbers of predicates, numbers of joins, aggregation presence, grouping complexity, range predicate presence, or other measurable plan features, provided the selected features are represented as nonnegative scalars and applied consistently.

For tree-based indexing, a recognition-optimized data structure manager (160) may determine or update sizing parameters for a recognition B+ tree subsystem (162). In a representative embodiment, the recognition B+ tree uses a node capacity parameter (350) that is computed from a record count N (or an integer-valued estimate) and the recognition coverage function (200). In one embodiment, the node capacity is computed as:

NodeCapacity_raw=F_cov(N,X_opt)*log 2(N)

NodeCapacity=ceil(NodeCapacity_raw)

where N is treated as a nonnegative count of records associated with a table, index, partition, shard, or other working set, and where the use of ceil converts a real-valued sizing expression into an integer-valued node capacity. The node capacity (350) may be applied by the recognition B+ tree (300) to determine allowable keys per node and to influence split and merge behavior during rebalancing, thereby affecting fan-out and height in a manner that is consistent across growth regimes.

For hash-based indexing, the recognition-optimized data structure manager (160) may determine or update sizing parameters for a recognition hash table subsystem (164). In a representative embodiment, a bucket count parameter (430) is computed as a function of record count N and the recognition coverage function (200). One example sizing form is:

BucketCount_raw=N*F_cov(N,X_opt)

BucketCount=ceil(BucketCount_raw)

A recognition hash function (460) may then be used to map keys to buckets as a transformation of a base hash function output (440) using a nonnegative key magnitude measure (450). In one embodiment:

h_rec(key)=(h0(key)*F_cov(len(key),X_opt))mod BucketCount

where h0(key) is a base hash function (440), len (key) is a nonnegative scalar key magnitude (450) such as key length in bytes or characters or another nonnegative key measure, and BucketCount is the bucket count parameter (430). This form incorporates bounded scaling into the hash mapping while preserving a deterministic mapping for identical key inputs, and supports consistent bucket utilization behavior across key regimes.

For probabilistic membership filtering, the recognition-optimized data structure manager (160) may determine or update sizing parameters for a recognition bloom filter subsystem (166). In a representative embodiment, a recognition bloom filter (500) includes a bit vector size parameter M (520) and a hash count parameter k (530), each computed using the recognition coverage function (200) to provide bounded scaling relative to the record count N and a configured false-positive target epsilon. One example form is:

M_raw=N*log 2(1/epsilon)*F_cov(N,X_opt)

M=ceil(M_raw)

k=ceil(log 2(1/epsilon)*F_cov(log 2(1/epsilon),X_opt))

where epsilon satisfies 0<epsilon<1. The parameter M (520) defines a number of bits in the bit vector and k (530) defines a number of hash functions or hash iterations used for insertion and membership checks. In this manner, the bloom filter parameters are computed from a common, bounded scaling primitive while retaining the deployment-configurable role of epsilon as an operational target that does not modify X_opt (220).

For resource allocation across concurrent work, a resource allocator (180) may implement recognition-weighted proportional allocation using the recognition coverage function engine (150). In one embodiment, a resource allocation module (600) divides a total resource budget R (610) across a set of concurrent tasks or queries using demand estimates, where each demand_i is computed as a nonnegative scalar by a demand estimator (630). A recognition-weighted allocation engine (640) computes per-task allocations (650) using:

Allocation(i)=R*F_cov(demand_i,X_opt)/sum_{j=1 . . . m}F_cov(demand_j,X_opt)

where demand_i>=0 for each task i, and the denominator is nonzero when at least one task has a nonzero demand. In implementations where all demands are zero, a default policy may allocate resources uniformly or may allocate a minimum baseline per task, provided the policy remains consistent with the resource budget R. The computed allocations (650) may be applied by a scheduler or queue manager to control CPU shares, memory grants, I/O tokens, thread quotas, or other allocable resources, and may be updated using monitoring feedback.

For execution path selection, an execution engine (170) may evaluate multiple candidate execution paths or plans and select a plan based on a bounded score formed from the recognition coverage function (200). In a representative embodiment, a candidate plan set (700) is produced, each candidate plan is assigned a positive cost estimate cost by a cost estimator (710), and resource feasibility is represented by an available resource measurement available (720) and a required resource estimate required (730). A path score calculator (740) computes a plan score as:

Score=F_cov(1/cost,X_opt)*F_cov(available/required,X_opt)

where cost >0, required >0, and available >=0. A path selector (750) selects the candidate plan having the maximum score, yielding a selected execution path (760) for execution. This score form combines a cost-based desirability term and a feasibility term under a shared bounded scaling primitive, so that plan comparisons remain stable across regimes and do not become dominated by extreme magnitudes.

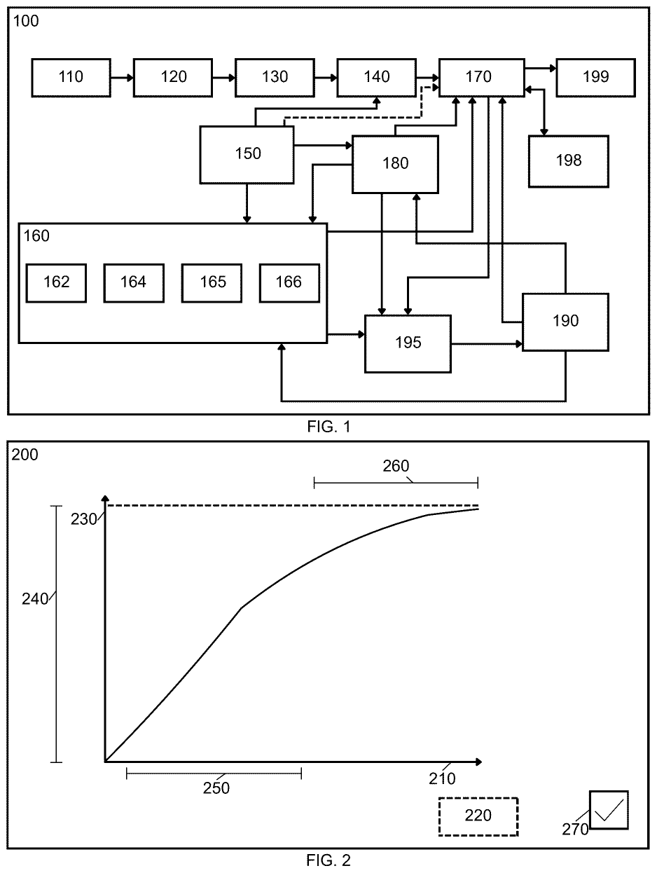

Referring to FIG. 1, an RDSA system (100) provides a recognition-based database query optimization pipeline that receives a query, derives query features and execution candidates, computes recognition-based scores and sizing parameters, selects an execution strategy, allocates execution resources, executes the selected strategy against a database or dataset, and outputs results. In representative implementations, the disclosed subsystems (including recognition-based complexity scoring, recognition-optimized access structure sizing, recognition-weighted plan scoring, and recognition-weighted resource allocation) operate as cooperating stages of the same query execution pipeline and share a bounded normalization primitive, thereby improving database operation rather than merely producing an abstract score. For example, the bounded and saturating behavior reduces oversizing/undersizing of access structures, reduces unnecessary downstream reads and index traversals, mitigates contention-driven tail latency via resource allocation stability, and reduces distributed fan-out and hot-spot effects when routing and partition behavior are informed by telemetry. The system (100) may be integrated into a database management system as part of a query optimizer, query planner, execution engine, scheduling layer, indexing subsystem, or any combination thereof, and may operate in a standalone deployment or in conjunction with external services that provide telemetry, workload statistics, or resource availability measurements.

The system (100) includes a query interface (110) that receives a query expressed in a query language or query API form. The query interface (110) may receive, along with the query, query context metadata such as tenant identifiers, consistency level, expected response class, or service-level target information. The query interface (110) forwards the received query to a query parser (120) that produces a parsed representation. The query parser (120) may produce, for example, an abstract syntax tree, a relational algebra form, a logical plan, or other structured representation from which plan operators, predicates, joins, aggregations, traversal steps, and other query elements can be identified.

The parsed representation is provided to a query analyzer and feature extractor (130). The query analyzer (130) derives one or more nonnegative query feature scalars that quantify the magnitude of query components, and may additionally derive candidate access paths and preliminary candidate execution plans. In representative implementations, the query analyzer (130) computes feature scalars that reflect operator counts, join counts, estimated cardinalities, predicate complexity, grouping complexity, range predicate presence, data locality estimates, or other plan-relevant magnitudes, provided each selected feature is represented as a nonnegative scalar suitable for use as a recognition input. The query analyzer (130) may also provide per-operator or per-stage work estimates and may annotate candidate plans with required resource estimates used for feasibility scoring and resource scheduling.

A complexity scorer (140) computes a complexity score for the query using query feature scalars produced by the query analyzer (130). The complexity scorer (140) may compute a single query-level complexity score, a per-stage complexity score, or a vector of complexity scores corresponding to query operators or candidate plan stages. In one embodiment, the complexity scorer (140) computes a normalized score by applying a recognition coverage function to each feature scalar and combining the resulting coverage values, such as by multiplication across selected features. The computed complexity score may be used to influence candidate plan ranking, admission control policies, resource allocation priorities, selection of indexing structures, or any combination thereof.

The system (100) includes a recognition coverage function engine (150) that computes the recognition coverage function used by multiple subsystems as a shared normalization primitive.

Referring to FIG. 2, the recognition coverage function engine (150) may compute a coverage output based on a nonnegative recognition input (210) and a fixed recognition constant (220), producing a bounded coverage output (230). The recognition coverage function engine (150) may be invoked to compute coverage values for query feature scalars, record counts, key magnitudes, resource demand magnitudes, inverse cost magnitudes, and ratios derived from availability and required resources. In some embodiments, the recognition coverage function engine (150) may also provide derived quantities such as cached coverage values, incremental update logic for coverage values when the underlying magnitudes change, and validation checks that enforce domain constraints (for example, enforcing nonnegativity of recognition inputs and positivity of denominators before evaluation).

The system (100) includes a recognition-optimized data structure manager (160) that computes, applies, and maintains recognition-based sizing parameters for database indexing and filtering structures. The data structure manager (160) may be invoked during index build time, index maintenance time, query planning time, periodic optimization time, or dynamically during runtime based on workload conditions. In representative embodiments, the data structure manager (160) includes an RB+ Tree subsystem (162), an R-Hash subsystem (164), a multi-dimensional recognition array subsystem (165), and a recognition bloom filter subsystem (166).

The data structure manager (160) may compute sizing parameters using the recognition coverage function engine (150) and apply those sizing parameters to instantiate new structures, resize existing structures, select among alternative structures, or configure structure-specific thresholds and maintenance schedules.

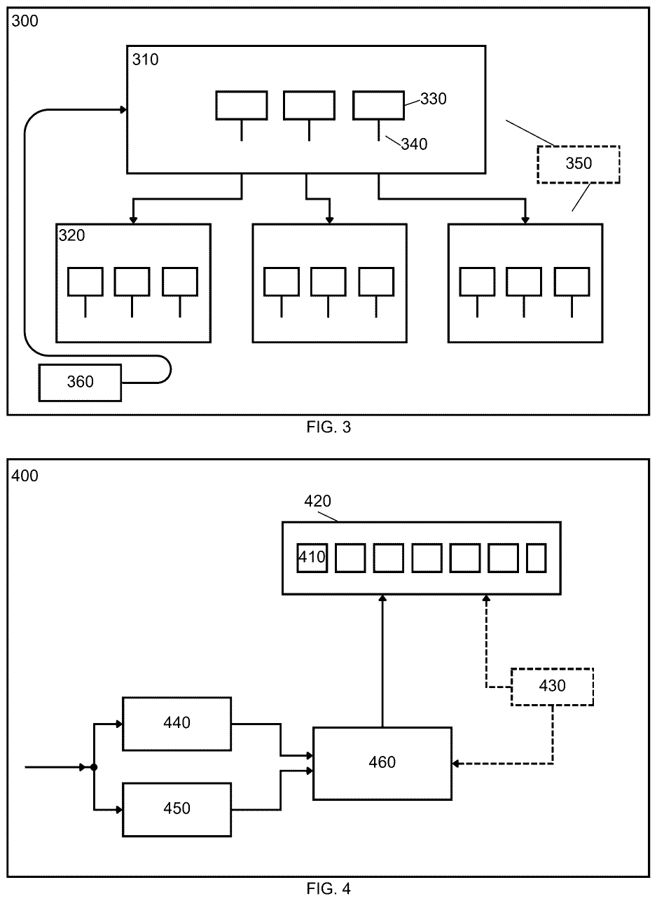

Referring to FIG. 3, the RB+ Tree subsystem (162) may implement a recognition B+ tree (300) whose node sizing is derived from recognition coverage values. The RB+ Tree subsystem (162) may determine a node capacity parameter (350) from a record count or record count estimate and may apply the resulting node capacity to internal nodes (310) and leaf nodes (320) that store keys (330) and pointers (340). The RB+ Tree subsystem (162) may perform split and merge operations (360) to preserve tree invariants and to maintain balanced behavior as records are inserted, deleted, or updated. The RB+ Tree subsystem (162) may compute node capacity parameters per table, per partition, per index, or per shard depending on deployment, and may update the node capacity parameter when record counts or workload characteristics change.

Referring to FIG. 4, the R-Hash subsystem (164) may implement a recognition hash table (400) whose bucket sizing and key-to-bucket mapping incorporate recognition coverage values. The R-Hash subsystem (164) may allocate a bucket array (420) comprising buckets (410) and compute a bucket count parameter (430) based on a record count or record count estimate. The R-Hash subsystem (164) may use a base hash function (440) to compute a baseline hash for a key and may compute a key magnitude value (450), such as a key length or other nonnegative key measure. A recognition hash function (460) may then combine the baseline hash output and a recognition coverage function value applied to the key magnitude to produce a bucket index mod the bucket count parameter (430). The R-Hash subsystem (164) may support rehashing and resizing policies consistent with the computed bucket count parameter, and may maintain statistics that allow bucket occupancy distributions and collision behavior to be monitored and adjusted.

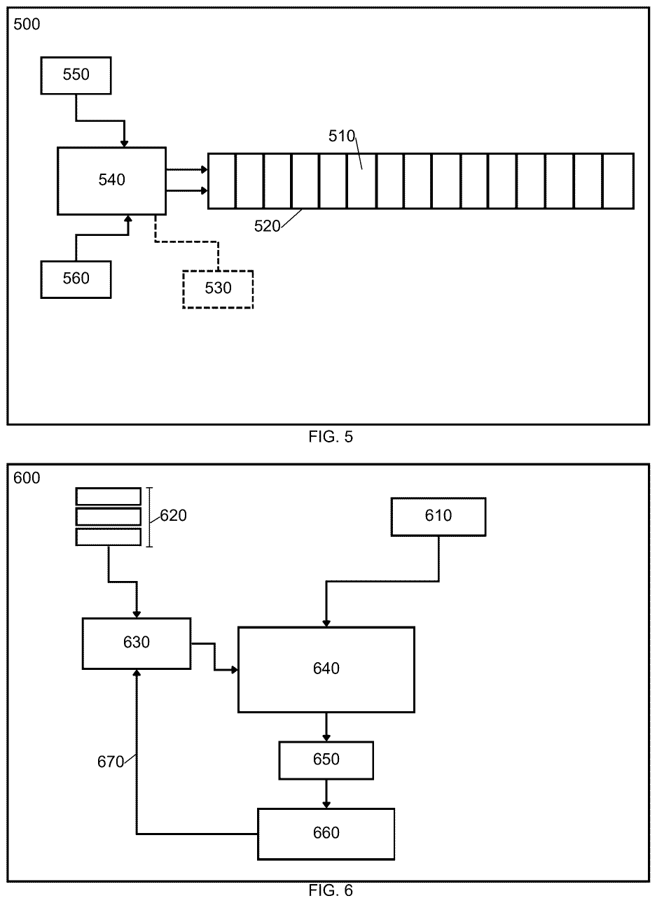

Referring to FIG. 5, the recognition bloom filter subsystem (166) may implement a recognition bloom filter (500) whose bit vector sizing and hash-count sizing incorporate recognition coverage values. The subsystem (166) may allocate a bit vector (510) with a bit vector size parameter (520) and may determine a hash count parameter (530) used with a hash function set or hash generator (540). The subsystem (166) may implement an insert path (550) that sets bits corresponding to hashed positions for inserted keys and a query path (560) that tests membership by checking bits corresponding to hashed positions for a queried key. The recognition bloom filter subsystem (166) may compute the bit vector size and hash count based on a record count estimate and a configured false-positive target while using the recognition coverage function engine (150) as a bounded scaling primitive. In some embodiments, the bloom filter subsystem (166) may be used as a pre-filter to reduce unnecessary downstream reads or index traversals and may be positioned in an execution pipeline before more expensive operations.

The multi-dimensional recognition array subsystem (165) provides structures and access accelerators for workloads with multi-attribute predicates or multi-dimensional access patterns, such as compound filtering, multi-attribute grouping, multi-dimensional range queries, or graph traversals where multiple dimensions of state must be considered. The subsystem (165) may store multi-dimensional bucket references, partition identifiers, index pointers, or other access accelerators organized across multiple dimensions. In one embodiment, the subsystem (165) computes dimension-specific or region-specific sizing and weighting decisions using the recognition coverage function engine (150), where each dimension or region is associated with a nonnegative magnitude such as a dimension cardinality estimate, a demand magnitude, or an access frequency magnitude.

The system (100) includes an execution engine (170) that receives candidate access paths and candidate plans and determines how to execute the query against the database/dataset (198). The execution engine (170) may generate additional candidate plans, may refine candidate plans based on current system conditions, and may select and execute a plan using recognition-based scoring. In one embodiment, the execution engine (170) receives candidate execution paths/plans and uses a scoring and selection pipeline that incorporates both cost and resource feasibility.

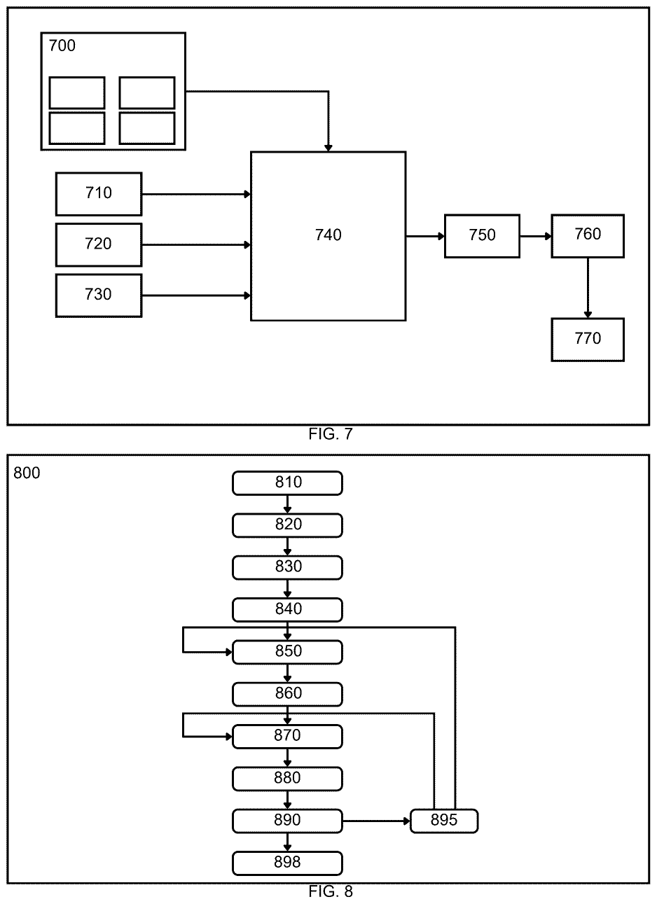

Referring to FIG. 7, candidate execution paths or plans (700) may be evaluated using a cost estimator (710) that produces a positive cost estimate, an available resource measurement (720) that represents current available resources, and a required resource estimate (730) that represents the required resources for the candidate plan. A path score calculator (740) computes a score for each candidate plan using recognition-based factors, and a path selector (750) selects the plan having the maximum score as the selected execution path/plan (760). The selected plan is provided to a plan execution interface (770) for execution by the execution engine (170). In representative implementations, the execution engine (170) may select between alternative index usage, alternative join orders, alternative join algorithms, alternative filtering orders, alternative partition access strategies, alternative distributed routing strategies, or combinations thereof.

The system (100) includes a resource allocator (180) that controls distribution of allocable resources across concurrent tasks, stages, or queries. The resource allocator (180) may operate at a query admission and scheduling layer, at an operator scheduling layer, or at a distributed coordination layer. Referring to FIG. 6, a resource allocator module (600) may allocate a total resource budget (610) across concurrent tasks/queries (620) based on demand estimates produced by a demand estimator (630). A recognition-weighted allocation engine (640) computes per-task allocation outputs (650), which are applied by a scheduler or queue manager (660) to control CPU shares, memory grants, I/O token budgets, network budgets, thread quotas, or other allocable resources. A monitoring feedback loop (670) may update demand estimates and allocations over time, including during execution, based on telemetry, queue conditions, backpressure signals, and observed runtime behavior.

The system (100) includes an adaptive optimizer (190) that monitors workload and performance behavior and performs dynamic adjustment without requiring manual tuning of the recognition constant. The adaptive optimizer (190) may monitor one or more telemetry or metrics sources (195), including latency statistics, throughput statistics, queue depths, cache hit rates, index health statistics, partition hot-spot indicators, or other workload indicators. Based on observed conditions, the adaptive optimizer (190) may trigger recalculation of recognition-based sizing parameters, may trigger maintenance or resizing of recognition-optimized structures in the data structure manager (160), may adjust plan selection preferences in the execution engine (170), and may influence resource allocation behavior in the resource allocator (180). In a distributed deployment, the adaptive optimizer (190) may coordinate adaptations across nodes and partitions, may request changes to routing strategies, and may adapt per-node resource budgets or per-partition weights based on localized telemetry.

During operation, the system (100) executes selected plans against a database or dataset (198) and provides query results via a result output (199). The result output (199) may include the retrieved records, computed aggregates, traversal results, or any other query outputs required by the query. In addition to results, the system (100) may optionally output execution metadata such as selected plan identifiers, computed scores, allocated resource shares, and summary execution statistics, which may be stored as telemetry/metrics (195) to support subsequent adaptation decisions by the adaptive optimizer (190).

Referring also to FIG. 8, the end-to-end operational flow of the system (100) may be represented as a method flow (800) that begins by receiving a query (810) via the query interface (110), parsing and analyzing the query (820) using the query parser (120) and the query analyzer and feature extractor (130), computing query feature scalars (830), and computing a query complexity score (840) using the complexity scorer (140) and the recognition coverage function engine (150). The method flow (800) may further include computing and applying recognition-based sizing parameters for one or more recognition-optimized data structures (850) via the recognition-optimized data structure manager (160), generating candidate plans (860), scoring and selecting an execution plan (870) using the candidate plan set (700), cost estimator (710), available resource measurement (720), required resource estimate (730), path score calculator (740), and path selector (750), allocating resources (880) using the resource allocator (180) and/or resource allocator module (600), executing the selected plan (890) via the execution engine (170) and plan execution interface (770), monitoring and adapting operation (895) using telemetry/metrics (195) and the adaptive optimizer (190), and outputting results (898) via the result output (199).

In connection with adaptive behavior, the monitor/adapt portion of the method flow (800) includes monitoring and adapting (895) based on runtime telemetry captured in the telemetry/metrics store (195). In representative implementations, the adaptive optimizer (190) uses such telemetry to trigger recalculation and application of recognition-based sizing parameters, to request maintenance or resizing actions in the recognition-optimized data structure manager (160), to influence plan scoring and selection behavior in the execution engine (170) including re-evaluation of candidate plans (700) and their scores computed by the path score calculator (740), and to update resource allocation behavior in the resource allocator (180) and/or resource allocator module (600), thereby coordinating architecture-level adaptation with the end-to-end flow shown in FIG. 8.

Referring to FIG. 8, an end-to-end method (800) is performed by the RDSA system (100) to optimize and execute database queries using recognition-based scoring, sizing, and allocation. In one embodiment, the method (800) is executed by one or more processors and comprises the following operations, which may be performed serially or with partial overlap where permitted by data dependencies.

The method begins by receiving a query (810) through a query interface (110). The received query may be expressed in SQL, in a NoSQL query format, or as an application programming interface call that is translated into an internal query representation. Along with the query, the query interface (110) may receive execution context, including one or more of a tenant identifier, a consistency level, an expected response class, a latency target, a throughput target, a priority level, or a permitted resource class.

The received query is parsed and analyzed (820). In this operation, a query parser (120) converts the query into a structured representation such as an abstract syntax tree, a logical plan, or a physical plan skeleton. A query analyzer and feature extractor (130) then derives a set of nonnegative feature scalars associated with the query (830). Each feature scalar is computed such that it is nonnegative and represents a magnitude associated with a query component. In representative implementations, the feature scalars include one or more of a join count magnitude, a predicate count magnitude, an aggregation presence magnitude, a grouping magnitude, an estimated cardinality magnitude, a range predicate magnitude, a traversal step magnitude, or other measurable plan-related magnitudes, provided each selected feature is represented as a nonnegative scalar.

After computing the feature scalars (830), a complexity score is computed (840) using a complexity scorer (140) and a recognition coverage function engine (150). In one embodiment, the complexity score is computed as a product of recognition coverage values across the feature scalars, where each recognition coverage value is computed using a recognition coverage function (200) with a fixed constant X_opt (220). The complexity score may be computed as a single scalar for the query, or as a set of per-stage or per-operator complexity scores. The computed complexity score is stored as planning metadata and is used to influence downstream decisions including candidate plan selection, admission control, and resource allocation.

The method continues by computing and applying recognition-based sizing parameters for one or more recognition-optimized data structures (850). In this operation, a recognition-optimized data structure manager (160) determines which structures are relevant to the query and to the targeted dataset, and computes one or more structure sizing parameters using the recognition coverage function engine (150). In one embodiment, the data structure manager (160) computes a node capacity parameter for a recognition B+ tree subsystem (162) that maintains a recognition B+ tree (300), computes a bucket count parameter for a recognition hash table subsystem (164) that maintains a recognition hash table (400), and computes a bit vector size parameter and a hash count parameter for a recognition bloom filter subsystem (166) that maintains a recognition bloom filter (500). The data structure manager (160) may additionally compute and apply sizing or weighting parameters for a multi-dimensional recognition array subsystem (165) for queries having multi-attribute predicates or multi-dimensional access patterns. The computed sizing parameters may be applied by instantiating a new structure, resizing an existing structure, selecting a structure among alternatives, or configuring maintenance thresholds. In some embodiments, when a structure resize would be disruptive, the data structure manager (160) schedules the resize as a maintenance task and applies interim parameters to minimize disruption while preserving correctness.

After sizing parameters are computed and applied (850), the method generates a set of candidate execution plans (860). In one embodiment, the candidate plans include alternative access paths and alternative execution strategies that differ by one or more of index usage, scan strategy, join ordering, join algorithm, predicate evaluation ordering, bloom-filter prefiltering, hash-based lookup, tree-based lookup, partition selection, and distributed routing strategy. The candidate plans may be generated by a query optimizer integrated with the database management system, or by a plan generation component of the execution engine (170). The candidate plans are represented as a candidate plan set (700).

For each candidate plan in the candidate plan set (700), the method computes plan inputs required for scoring and feasibility. In one embodiment, a cost estimator (710) produces a positive cost estimate for each candidate plan, where the cost estimate represents an expected latency, expected resource consumption, or a composite cost expressed in normalized units. In addition, an available resource measurement (720) is obtained for the current execution environment, and a required resource estimate (730) is obtained for each candidate plan. The available resource measurement (720) may be derived from a scheduler, queue manager, node telemetry, or a resource manager, and may represent available CPU capacity, available memory, available I/O bandwidth, available network budget, available thread slots, or a composite availability metric. The required resource estimate (730) may be derived from the candidate plan's estimated work size, operator requirements, memory footprint, intermediate result size, and other plan features, and represents a positive required amount for feasibility evaluation.

The method then scores and selects an execution plan (870). In one embodiment, a path score calculator (740) computes, for each candidate plan, a plan score formed from two recognition-coverage factors: a desirability factor based on inverse cost and a feasibility factor based on an availability-to-requirement ratio. The inverse cost is computed as 1/cost, with cost strictly positive, and the feasibility ratio is computed as available/required, with required strictly positive. Each factor is mapped through the recognition coverage function using X_opt (220).

The plan score is computed as a product of the two recognition coverage values, producing a nonnegative score for each candidate plan. A path selector (750) selects the candidate plan having the maximum plan score, thereby producing a selected execution path/plan (760). If two or more plans tie within a configured tolerance, the selector may apply a deterministic tie-breaker, such as preferring the plan with lower estimated cost, preferring the plan with higher feasibility ratio, or preferring a plan that minimizes cross-partition data movement.

After selecting the execution plan (870), the method allocates resources (880) to the selected plan and to concurrent work. In one embodiment, a resource allocator (180) or a resource allocator module (600) identifies a set of concurrent tasks (620) that includes at least the selected plan and optionally additional tasks such as background maintenance, prefetching, index maintenance, or other queries. A demand estimator (630) computes a nonnegative demand magnitude for each task, where demand magnitudes may incorporate one or more of the computed complexity score, estimated work size, queue backlog, service-level target urgency, and observed runtime behavior. A recognition-weighted allocation engine (640) computes an allocation for each task as a share of a total resource budget (610) using recognition coverage values computed from the demand magnitudes. The allocation outputs (650) are then applied by a scheduler or queue manager (660) to assign CPU time slices, memory grants, I/O tokens, network budgets, thread quotas, or other resource controls consistent with the computed allocations. If the denominator in the allocation computation is zero because all computed demand magnitudes are zero, the resource allocator applies a default allocation policy, such as uniform allocation or a baseline allocation per task, while preserving the total budget constraint.
In one non-limiting example, the demand estimator computes demand_i as a weighted sum of nonnegative terms, such as demand_i=aComplexityScore_i+bWorkSize_i+cQueueDepth_i+dUrgency_i, where a, b, c, d are nonnegative coefficients and each term is computed as a nonnegative scalar. Other monotone nonnegative combinations may be used provided demand_i>=0.

The method executes the selected plan (890). In one embodiment, the selected execution plan (760) is handed to a plan execution interface (770) and executed by the execution engine (170) against the database or dataset (198). During execution, one or more recognition-optimized data structures managed by the data structure manager (160) are accessed in accordance with the selected plan, including, where applicable, a recognition bloom filter (500) for prefiltering membership checks, a recognition hash table (400) for key-based lookup, a recognition B+ tree (300) for ordered access or range filtering, and a multi-dimensional recognition array for multi-dimensional access acceleration. Execution produces query results that are output (898) through a result output (199). The output may include records, computed aggregates, traversal results, or other query outputs required by the query.

The method monitors and adapts (895) based on runtime telemetry, thereby enabling the system to remain stable under workload variation while preserving the fixed-constant posture of X_opt (220). In one embodiment, telemetry and metrics are collected in a telemetry/metrics store (195), including one or more of observed latency, throughput, queue depth, cache hit rate, filter effectiveness, index health, partition hot-spot indicators, and resource utilization. An adaptive optimizer (190) evaluates such telemetry to determine whether to trigger one or more corrective actions, including recalculation and application of recognition-based sizing parameters in the data structure manager (160), adjustment of plan scoring and selection inputs for subsequent queries in the execution engine (170), and adjustment of demand estimation and resource allocation behavior in the resource allocator (180) or resource allocator module (600). In some embodiments, adaptation is triggered when a monitored metric crosses a threshold, when a baseline band is violated, when a trend persists over a configured window, or on a periodic cadence. Where adaptation includes resizing an index or filter structure, the adaptive optimizer (190) may schedule the resizing operation to avoid interfering with active service-level targets while still converging toward the computed recognition-based sizing parameters.
In one non-limiting implementation, telemetry is aggregated in fixed monitoring windows of 1-60 seconds (e.g., 10 seconds) and a trend is treated as persisting when a metric exceeds a baseline for at least 3 consecutive windows. In one example, an adaptation action is triggered when P99 latency exceeds a configured service-level objective by at least 5-20% for the persistence condition, or when queue depth exceeds a configured capacity by at least a threshold amount for the persistence condition. These numeric examples are optional and may be configured per deployment while preserving the fixed-constant posture of X_opt.

In this manner, the end-to-end method (800) provides a unified operational flow in which query analysis, complexity scoring, recognition-based data structure sizing, plan scoring and selection, recognition-weighted resource allocation, execution, and monitoring-driven adaptation are coordinated under a shared recognition coverage function framework, while keeping the recognition constant X_opt (220) fixed and not empirically tuned per workload.

Referring to FIG. 1, the system (100) supports recognition-optimized multi-scale data partitioning in which a dataset is partitioned and maintained across multiple scales of granularity so that query execution may reduce I/O amplification, improve locality, and avoid persistent hot-spots while preserving correctness. In this context, “multi-scale” refers to partitioning at two or more of: a table or collection level, an index level, a segment or block level within a node, and a shard or partition level across nodes in a distributed deployment. Multi-scale partitioning may be applied to relational tables, key spaces, document collections, time-series partitions, graph structures, or other database storage organizations, and may be used in combination with recognition-optimized structures managed by the recognition-optimized data structure manager (160).

In one embodiment, the database/dataset (198) is partitioned into a set of partitions, where each partition is associated with a partition magnitude that is represented as one or more nonnegative scalars. Non-limiting examples of partition magnitudes include partition record count, partition cardinality estimate, access frequency, write rate, read rate, cache residency pressure, intermediate-result expansion, and observed latency contribution. These magnitudes may be derived from query telemetry, planner estimates, and runtime measurements, and are used to inform partition sizing, partition boundaries, and partition-level resource weights. The recognition coverage function engine (150) maps such nonnegative magnitudes into bounded coverage values using the fixed constant X_opt (220), thereby providing a stable normalization primitive that can be applied consistently across partitions and scales.

Partitioning decisions may be expressed as one or more of: selecting a partitioning key, selecting a number of partitions, selecting partition boundary thresholds, selecting a shard count, selecting a replica strategy, or selecting a placement strategy across nodes. In a representative embodiment, partition management decisions are performed by or under control of the adaptive optimizer (190) based on telemetry/metrics (195), and the decisions may be applied by scheduling maintenance actions that create, split, merge, or relocate partitions. For example, when a partition's workload magnitude increases, a split operation may be triggered to reduce the working set per partition and improve locality; when a partition's workload magnitude decreases or becomes sparse, a merge operation may be triggered to reduce overhead. The decision to split or merge may be based on recognition coverage values computed from partition magnitudes so that the triggering behavior remains bounded and saturating, preventing extreme magnitudes from forcing unbounded partition proliferation.

Referring to FIG. 10, in a distributed deployment the system (100) may operate as a distributed database cluster (1000) including a coordinator node (1010) and multiple database nodes (1020) that store and serve shards/partitions (1030). The cluster (1000) may include replicas (1040) and may route queries over a network fabric (1050) using a routing/query distribution module (1080).

In this distributed setting, multi-scale partitioning includes both intra-node partitioning within a node (1020) and inter-node partitioning across nodes. A shard/partition (1030) may represent a logical range partition, a hash partition, a time-window partition, a graph substructure partition, or another partition scheme. Placement decisions may assign shards to nodes, balance shard distribution across regions, and select replica counts or replica placement to meet availability targets.

In one embodiment, the routing/query distribution module (1080) uses recognition-weighted metadata to select which partitions or shards to access for a given query and to determine how to distribute work across nodes. For example, partition selection may consider per-partition demand magnitudes and per-partition availability conditions. Referring to FIG. 7, candidate execution paths/plans (700) may include alternative partition access strategies that differ by which shards are contacted, whether access is parallelized across nodes, and whether certain partitions are pruned or prefiltered. A cost estimator (710) may estimate the cost of each candidate partition access strategy, and the plan score calculator (740) may compute a plan score that combines recognition coverage values derived from inverse cost and feasibility ratios, thereby selecting a partition access strategy that is both efficient and feasible under current cluster conditions.

Multi-scale partitioning is coordinated with resource allocation. Referring to FIG. 6, a per-node resource allocator (1060) may operate on a node (1020) to apply recognition-weighted allocations across tasks, including shard-level subqueries, operator-level work units, maintenance actions, and background tasks. A resource allocator module (600) may allocate a total resource budget (610) across concurrent tasks (620) based on demand estimates produced by a demand estimator (630), with allocations computed by a recognition-weighted allocation engine (640) and applied by a scheduler/queue manager (660). In a distributed system, allocations may be performed independently on each node using node-local demand magnitudes, and may also be coordinated at the coordinator node (1010) using cluster-wide telemetry aggregated by a telemetry aggregator (1070). In some embodiments, partition-level demand magnitudes are used as inputs to demand estimation, such that partitions experiencing higher demand receive higher allocations, while bounded coverage ensures allocation weights saturate rather than grow without bound.

Partition maintenance and partition adaptation may be performed dynamically while preserving end-to-end correctness. Referring to FIG. 8, the monitor/adapt stage (895) uses telemetry/metrics (195) to determine whether to trigger partition maintenance actions, including partition splitting, merging, relocation, or rebalancing of replica placement. Such actions may be scheduled to reduce interference with active query execution, for example by triggering maintenance during lower utilization windows, by rate-limiting partition movement, or by performing incremental rebalancing steps. When partition adaptation occurs, the system may also update relevant recognition-optimized structures within affected partitions via the recognition-optimized data structure manager (160), including resizing or rebuilding a recognition bloom filter (500), rehashing or resizing a recognition hash table (400), or updating the node capacity behavior of a recognition B+ tree (300) as record counts and access patterns change.

In this manner, recognition-optimized multi-scale data partitioning provides a consistent framework for partition selection, partition sizing, and partition adaptation across single-node and distributed deployments. Partitioning decisions are driven by nonnegative magnitudes mapped through a bounded, saturating recognition coverage function so that the system can respond to workload changes without relying on empirically tuned constants, while still enabling implementable actions such as shard splitting, shard merging, shard relocation, and recognition-weighted resource allocation across partition-scoped tasks.

Referring to FIG. 1, the system (100) may include a multi-dimensional recognition array subsystem (165) that accelerates query planning and execution for workloads involving multi-dimensional data and/or multi-attribute predicates. The multi-dimensional recognition array, also referred to herein as “MD-RA” (165), provides a structured representation of multi-dimensional access regions and can be used to reduce search space, prune candidate partitions, and accelerate retrieval for queries that include multiple correlated constraints. In representative embodiments, the MD-RA (165) is used with datasets stored in relational databases, document stores, columnar stores, time-series stores, and graph databases, including cases where query predicates span multiple attributes and where efficient selection of candidate records depends on joint consideration of multiple dimensions.

In one embodiment, the MD-RA (165) is implemented as a logical array having two or more dimensions, where each dimension corresponds to an attribute, feature, or indexable property of stored records. A dimension may correspond to, by way of non-limiting example, a numeric attribute, a categorical attribute, a time attribute, a spatial attribute, a hashed attribute, or a derived attribute computed from record content. The MD-RA (165) stores, for each multi-dimensional region, one or more access accelerators such as pointers to partitions, pointers to index ranges, pointers to bucket sets, identifiers for candidate shards/partitions, or identifiers for candidate record blocks. These stored accelerators allow a query to rapidly map a multi-attribute predicate region to a reduced set of candidate storage regions that should be searched, thereby reducing unnecessary scanning and reducing the number of irrelevant partitions contacted in a distributed system.

The MD-RA (165) may be populated and maintained using statistics derived from the database/dataset (198), and may be updated as the dataset and workload evolve. In one embodiment, the MD-RA (165) is maintained by the recognition-optimized data structure manager (160) under the supervision of the adaptive optimizer (190), based on telemetry/metrics (195) that describe workload patterns and observed query behavior. Updates may include creating new regions, resizing regions, merging regions, splitting regions, and updating the stored accelerators for each region. These updates may be performed on a periodic cadence, may be triggered by workload thresholds, or may be triggered by detection of persistent hot-spots or persistent inefficiencies.

Recognition-based scaling is applied to MD-RA configuration and maintenance so that the MD-RA adapts without requiring empirically tuned scaling constants. In one embodiment, the recognition coverage function engine (150) computes recognition coverage values using the recognition coverage function (200) based on a nonnegative magnitude input (210) and the fixed constant X_opt (220), producing a bounded output (230). The MD-RA (165) uses such recognition coverage values to scale one or more of: a number of regions maintained per dimension, a number of buckets or bins per dimension, a number of stored accelerators per region, a threshold for splitting or merging regions, or a weight used when ranking candidate storage regions for a query. In representative implementations, the nonnegative magnitude inputs used for recognition scaling include one or more of a dimension cardinality estimate, a region record count estimate, a region access frequency magnitude, a region write rate magnitude, a region cache pressure magnitude, or a region demand magnitude derived from observed query plans. Because the recognition coverage output is bounded and saturating, increases in these magnitudes do not force unbounded growth in array resolution, thereby preventing runaway region fragmentation while still allowing increased resolution where it is beneficial.

During query processing, the MD-RA (165) may be used to prune and prioritize candidate execution strategies. Referring to FIG. 8, during the parsing and analysis stage (820) and the feature computation stage (830), the query analyzer and feature extractor (130) identifies the query's multi-dimensional predicate constraints and maps the constraints to one or more regions of the MD-RA (165). The MD-RA (165) outputs candidate region accelerators, such as candidate partition identifiers, candidate index ranges, or candidate bucket sets. These outputs are provided as constraints or hints to candidate plan generation (860) and may reduce the number of candidate plans that must be generated and evaluated. In some embodiments, MD-RA outputs are also used to adjust cost estimates produced by the cost estimator (710) by reducing estimated scan volume or by reducing estimated partition fan-out, thereby influencing plan scoring and selection (870).

In an execution embodiment, the selected execution plan (760) uses the MD-RA (165) to accelerate record retrieval by restricting the search to the storage regions indicated by the MD-RA outputs. For example, for a query that specifies multiple range constraints on numeric attributes, the MD-RA (165) may identify a small set of candidate index ranges and partitions likely to contain matching records, thereby reducing the number of index traversals and reducing the amount of data scanned. For a query that specifies multiple categorical constraints, the MD-RA (165) may identify candidate bucket sets or candidate partition subsets. In some embodiments, MD-RA outputs are combined with a recognition bloom filter (500) to prefilter candidates before more expensive index lookups, and the combined approach reduces wasted reads by removing non-membership candidates early in an execution pipeline.

Referring to FIG. 10, in a distributed database cluster (1000) the MD-RA (165) may be used to reduce cross-node fan-out by identifying a subset of shards/partitions (1030) likely to contain results. The routing/query distribution module (1080) may use MD-RA outputs to route subqueries to selected database nodes (1020), and may reduce the number of contacted nodes relative to a baseline approach that broadcasts to all nodes. In some embodiments, the MD-RA (165) is maintained in a coordinator node (1010) as a global structure used for routing decisions, while in other embodiments the MD-RA is replicated across nodes to support local pruning decisions and to avoid centralized bottlenecks. A telemetry aggregator (1070) may collect region-level statistics to support MD-RA updates and to support recognition-weighted scaling of region resolution.

The MD-RA (165) may also be applied to graph-database and recommendation workloads in which traversal or candidate selection depends on multiple dimensions of state. In such embodiments, dimensions may encode one or more of node properties, edge properties, traversal depth, time windows, or learned feature bins derived from record attributes. The MD-RA (165) may be used to constrain a traversal or candidate search to a reduced multi-dimensional region, thereby reducing exploration of irrelevant subgraphs and reducing intermediate-result explosion.

Where intermediate-result explosion is a concern, MD-RA pruning may be coordinated with resource allocation. Referring to FIG. 6, demand estimates and allocations may be computed for MD-RA-assisted tasks so that compute and memory budgets scale with bounded recognition weights derived from region demands, thereby stabilizing execution under large-scale or bursty workloads.

In this manner, the multi-dimensional recognition array subsystem (165) provides a recognition-scaled multi-dimensional access accelerator that improves query efficiency by reducing search space and by reducing candidate plan and partition fan-out. Recognition-based scaling via the recognition coverage function (200) and fixed constant X_opt (220) provides stable MD-RA configuration across regimes without workload-tuned parameters, while integration with candidate plan generation (860), plan scoring and selection (870), and distributed routing (1080) provides implementable end-to-end acceleration for multi-dimensional database queries.

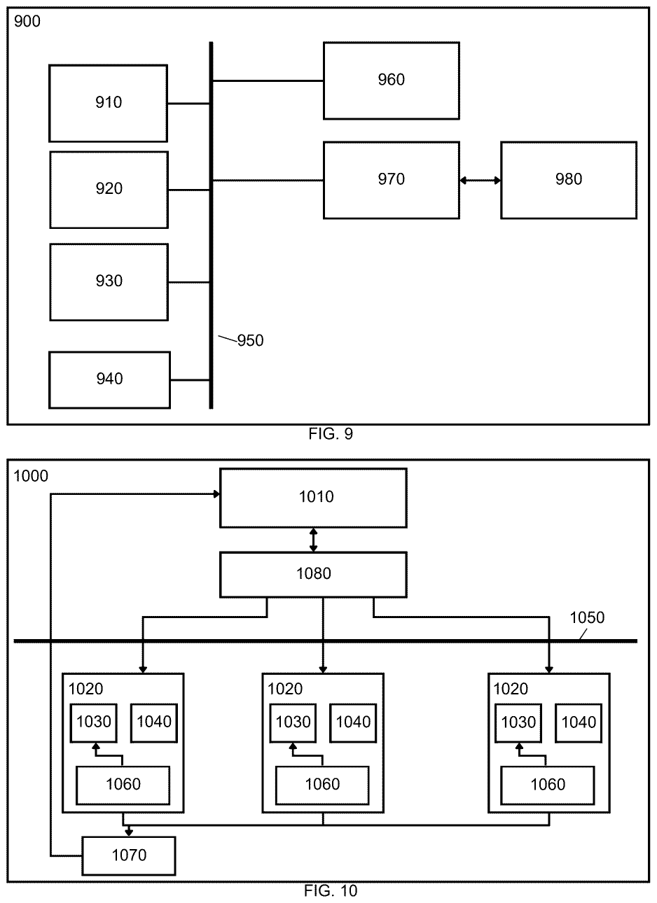

Referring to FIG. 9, the RDSA instruction module (970) may be implemented as one or more software components that execute on a computing system (900) including one or more processors (910) and memory (920) and that interact with DBMS software (960). In representative embodiments, the RDSA instruction module (970) is integrated into an existing database system as a set of callable functions, optimizer extensions, planner rules, executor hooks, scheduler policies, and/or maintenance tasks. Integration may be performed in a manner that preserves the host DBMS correctness and transactional semantics, while allowing the RDSA logic to influence plan selection, data structure sizing, and resource allocation.

Referring to FIG. 1, integration points may be organized around the pipeline components of the system (100). A query interface (110) may be implemented as an API endpoint, SQL gateway, driver-level interceptor, stored procedure interface, RPC interface, or internal optimizer entrypoint. A query parser (120) may be the host DBMS parser or a wrapper that converts a query representation into a structured form usable by the query analyzer and feature extractor (130). The query analyzer (130) may be implemented as an optimizer-phase analyzer that inspects a logical plan and/or physical plan candidates to derive nonnegative feature magnitudes.

The complexity scorer (140) and recognition coverage function engine (150) may be implemented as library functions callable by the optimizer, the planner, and/or the executor. The execution engine (170) may be the host DBMS executor or a wrapper that selects among candidate plans and schedules execution. The resource allocator (180) may be implemented as part of the host DBMS scheduler, queue manager, or admission controller, and the adaptive optimizer (190) may be implemented as a background task that monitors telemetry/metrics (195) and triggers resizing, rebalancing, and policy updates.

In one embodiment, integration with a relational database management system is performed by inserting RDSA logic into the query planning and optimization layer. The query analyzer and feature extractor (130) may compute feature magnitudes from SQL query structure and from optimizer estimates, including join counts, predicate counts, grouping/aggregation presence, and cardinality estimates derived from statistics. Candidate plan generation may be performed by the host optimizer, and the RDSA execution logic may score candidate plans and select a plan using the plan-selection pipeline described with respect to FIG. 7. The recognition-optimized data structure manager (160) may integrate with index creation and maintenance workflows by selecting or configuring index structures and filter structures based on record counts and workload telemetry. For example, the RB+ Tree subsystem (162) may be implemented as a variant of a B+ tree index module where node capacity (350) is computed and applied for the index; the R-Hash subsystem (164) may be implemented as a hash-index module whose bucket count (430) and key-to-bucket mapping incorporate the recognition hash function (460); and the recognition bloom filter subsystem (166) may be implemented as a prefilter layer attached to one or more access paths. In a relational system, such filters may be applied before index lookup or before table scan, thereby reducing downstream work when non-membership can be detected early.

In one embodiment, integration with a document store or key-value store is performed by inserting RDSA logic into a routing layer, a query planner, and a storage-engine access layer. For example, key-based lookup operations may be accelerated using a recognition hash table (400) and/or a recognition bloom filter (500), and the RDSA logic may determine whether to use a hash-based access path, a tree-based access path, or a filtered scan path based on plan scoring.

Where the host system supports secondary indexes, the recognition-optimized data structure manager (160) may compute sizing parameters and may select a specific index embodiment for a collection or key space. For document stores, query analyzer feature magnitudes may incorporate the number of document fields referenced, predicate complexity across fields, and cardinality estimates derived from field statistics. For key-value stores, feature magnitudes may incorporate key access patterns, hot-key detection, and concurrency levels.

In one embodiment, integration with an in-memory database is performed by inserting RDSA logic into memory management and scheduling layers in addition to plan selection. In-memory systems often have tight coupling between operator scheduling and memory residency, and the resource allocator (180) may allocate CPU and memory budgets among concurrent queries using recognition-weighted allocation as described with respect to FIG. 6. The recognition-optimized data structure manager (160) may be used to size in-memory index structures and probabilistic filters in a manner that accounts for record counts and configured false-positive targets while using the fixed recognition constant. In such embodiments, telemetry/metrics (195) may include cache residency metrics, memory pressure metrics, and contention metrics, and the adaptive optimizer (190) may adjust sizing and scheduling policies to stabilize tail latency under burst loads.

In one embodiment, integration with a time-series database is performed by leveraging the naturally partitioned structure of time-series data. Time-series systems typically maintain time-window partitions, compression segments, or chunk structures, and the system may apply recognition-based sizing and selection to accelerate time-window queries. For example, recognition bloom filters (500) may be used as prefilters for time-window partitions to reduce unnecessary reads, and the recognition-optimized data structure manager (160) may compute filter sizes per time partition based on record counts for the partition. Multi-scale partitioning described with respect to FIG. 10 may be applied using time-window shard placement and routing strategies, and the query analyzer may use query feature magnitudes that encode time-window width, predicate complexity, and expected selectivity.

In one embodiment, integration with a graph database is performed by incorporating recognition-based scoring into traversal planning and by using the multi-dimensional recognition array subsystem (165) to constrain candidate expansion. Graph queries often generate intermediate results that expand rapidly with traversal depth, and candidate pruning is used to keep execution feasible. The MD-RA subsystem (165) may encode multi-dimensional constraints based on node properties, edge properties, time windows, traversal depth, and/or learned bins for properties.

These constraints may be used to prune candidate traversals and to reduce intermediate-result explosion. The execution engine (170) may treat alternative traversal strategies as candidate plans (700) and score them using the path score calculator (740) and selector (750) based on cost and feasibility.

Referring to FIG. 10, in a distributed database deployment the system may be integrated at both a coordinator and node level. A coordinator node (1010) may perform global query analysis, candidate plan generation, and routing decisions, while database nodes (1020) perform shard-local execution. Shards/partitions (1030) and replicas (1040) may be managed by the host DBMS, and RDSA logic may influence which shards are contacted, the degree of parallelism across nodes, and per-node scheduling. The routing/query distribution module (1080) may use recognition-weighted metadata to reduce fan-out, and telemetry may be aggregated by a telemetry aggregator (1070) to support adaptive optimization across the cluster. Per-node resource allocators (1060) may apply recognition-weighted allocations for shard-local tasks, while the coordinator may apply higher-level policies that distribute work across nodes based on cluster-wide availability and demand.

Referring to FIG. 8, integration may support both per-query decisions and periodic adaptation decisions. Per-query decisions include computing feature magnitudes (830), computing complexity scores (840), generating and scoring candidate plans (860, 870), allocating resources (880), and executing the selected plan (890). Periodic adaptation decisions include monitoring and adapting (895) based on telemetry, triggering resizing or rebuilding of recognition-optimized data structures via the data structure manager (160), updating partitioning and routing policies in distributed settings, and updating resource allocation policies and demand estimation logic. In a representative embodiment, the adaptive optimizer (190) executes as a background service that periodically evaluates telemetry/metrics (195), applies threshold and trend rules, and triggers maintenance actions while preserving correctness and service-level targets.

In this manner, the RDSA system (100) is integrable across database classes by attaching to common DBMS interfaces including query parsing, optimization, execution, indexing, filtering, scheduling, and maintenance. The integration embodiments allow recognition-based sizing, recognition-based plan scoring, and recognition-weighted resource allocation to be introduced without replacing the host DBMS core, and allow the system to operate in single-node and distributed deployments using the same fixed recognition constant and shared recognition coverage function framework.

Referring to FIG. 1, FIG. 3, and FIG. 8, in one representative enterprise OLTP embodiment the system (100) is integrated with a relational DBMS and evaluated using a standardized benchmark workload. In this embodiment, the workload is executed on PostgreSQL using the TPC-H benchmark with a 10 GB dataset associated with the database/dataset (198). The query interface (110), query parser (120), query analyzer/feature extractor (130), complexity scorer (140), and recognition coverage function engine (150) cooperate to generate a recognition-informed execution plan that is executed by the execution engine (170), while adaptation and maintenance are coordinated by the adaptive optimizer (190) using telemetry/metrics (195).

Referring to FIG. 3, the recognition B+ tree (300) is enabled via the RB+ Tree subsystem (162), and the node capacity parameter (350) is computed and applied to internal nodes (310) and leaf nodes (320) holding keys (330) and pointers (340), with split/merge (rebalancing) logic (360) maintaining tree invariants under updates. In this representative evaluation, the RDSA pipeline reduces average query time from 2.4 seconds to 1.1 seconds, corresponding to a 54% speedup, while also reducing memory usage by 32%. In the same embodiment, the computed RB+ Tree node capacity is 47, compared to a standard node capacity of 128, and the reduced node capacity is applied to improve access locality and index traversal behavior for the evaluated workload.

Referring to FIG. 4, FIG. 7, and FIG. 8, in one representative NoSQL analytics embodiment the system (100) is integrated with a document store and evaluated using a standardized key-value style workload. In this embodiment, the workload is executed on MongoDB using the YCSB benchmark with 100 million records stored in the database/dataset (198). The recognition hash table (400) is enabled via the R-Hash subsystem (164), where a bucket array (420) comprising buckets (410) is sized using a bucket count parameter (430) computed as a function of record count and the recognition coverage function (200) using X_opt (220). A base hash function h0(key) (440) and a key magnitude function len(key) (450) are combined via a recognition hash function (460) to map keys into the bucket array. Candidate plans (700) may include alternatives that favor hash-based retrieval or alternative access strategies, and the path score calculator (740) and path selector (750) select a plan (760) that balances inverse-cost desirability and feasibility based on available resources (720) and required resources (730). In this representative evaluation, read latency is reduced from 0.8 ms to 0.35 ms, corresponding to a 56% reduction, and write throughput improves by 25% as a result of recognition-based sizing and plan selection.

Referring to FIG. 6, FIG. 7, FIG. 10, and FIG. 8, in one representative distributed database embodiment the system (100) is deployed as part of a multi-region cluster and evaluated on a large-scale dataset. In this embodiment, the cluster is implemented using CockroachDB as a distributed database cluster (1000) including a coordinator node (1010) and multiple database nodes (1020) that serve shards/partitions (1030) and replicas (1040) over a network fabric (1050), with query routing and distribution performed by a routing/query distribution module (1080) and telemetry aggregated by a telemetry aggregator (1070). The database/dataset (198) in this embodiment is 1 TB in size, and resource allocation is applied across 16 nodes. Referring to FIG. 6, per-node resource allocators (1060) and a resource allocator module (600) compute and apply recognition-weighted allocations across concurrent tasks (620) using a demand estimator (630), a recognition-weighted allocation engine (640), and allocation outputs (650) applied by a scheduler/queue manager (660), with monitoring feedback (670). Referring to FIG. 7, query routing and plan selection are optimized by scoring candidate plans (700) using cost estimates (710) and feasibility ratios derived from available resources (720) and required resources (730), producing a plan score via the path score calculator (740) and selecting a plan (760) via the path selector (750). Referring to FIG. 8, monitoring/adaptation (895) coordinates allocation updates and routing updates based on telemetry/metrics (195). In this representative evaluation, P99 latency is reduced from 12 ms to 5.5 ms, corresponding to a 54% reduction.

Referring to FIG. 5, FIG. 1, and FIG. 8, in one representative time-series IoT embodiment the system (100) is integrated with a time-series database and evaluated on a large sensor dataset. In this embodiment, the workload is executed on TimescaleDB with 500 million sensor records stored in the database/dataset (198). The recognition bloom filter (500) is enabled via the recognition bloom filter subsystem (166), where the bit vector (510) is sized using the bit vector size parameter M (520) and the number of hash functions is set using the hash count parameter k (530), implemented using a hash function set or generator (540) with an insert path (550) and query path (560). The bloom filter is used as a prefilter to reduce unnecessary downstream reads when executing time-range queries. In this representative evaluation, the recognition bloom filter reduces false positives by 40% relative to a standard bloom filter at the same memory budget, and time-range queries are 38% faster as a result of improved prefilter behavior and reduced wasted I/O.

Referring to FIG. 1, FIG. 7, FIG. 6, FIG. 10, and FIG. 8, in one representative graph database embodiment the system (100) is applied to traversal workloads and intermediate-result management. In this embodiment, the workload is executed on Neo4j for a social network dataset having 50 million nodes. A multi-dimensional recognition array subsystem (165) is used to accelerate multi-hop traversal by constraining candidate expansion and reducing exploration of irrelevant subgraphs. Candidate traversal strategies are treated as candidate execution plans (700), scored using the path score calculator (740), and selected by the path selector (750) based on inverse-cost desirability and feasibility under current resource conditions. Resource allocation is used to prevent hot-spot overload by allocating CPU, memory, and I/O resources across concurrent traversal tasks using the resource allocator module (600) and the recognition-weighted allocation engine (640). In this representative evaluation, the multi-dimensional recognition array accelerates 3-hop traversals by 45%, and recognition-weighted resource allocation prevents persistent overload at hot-spot regions by distributing resources proportional to bounded recognition weights derived from demand magnitudes.

Referring to FIG. 1, FIG. 8, FIG. 9, and FIG. 10, in one representative cloud DBaaS embodiment the system (100) is deployed within a managed database service environment. In this embodiment, the system is applied to AWS RDS and uses telemetry-driven auto-scaling based on recognition coverage metrics computed by the recognition coverage function engine (150) and stored in the telemetry/metrics store (195). Referring to FIG. 8, the monitor/adapt stage (895) triggers periodic and event-driven adjustments, including resizing and reconfiguration of recognition-optimized data structures via the recognition-optimized data structure manager (160), and updating plan selection and resource allocation policies in the execution engine (170) and resource allocator (180). Referring to FIG. 9, the RDSA instruction module (970) executes on processor(s) (910) using memory (920) and interacts with DBMS software (960), while logs and telemetry may be persisted in a telemetry/log store (980). In this representative evaluation, CPU provisioning is reduced by 30% while maintaining service-level objectives, and the adaptive optimizer (190) re-sizes RB+ Trees daily based on workload pattern changes, thereby reducing over-provisioning while preserving performance targets.

Referring to FIG. 1, the system (100) provides a unified recognition-based query optimization pipeline that couples query analysis, complexity scoring, data structure sizing, plan selection, and resource allocation into an integrated workflow. This unified approach reduces fragmentation between independent tuning knobs, and enables consistent, measurable optimization effects across indexing, planning, scheduling, and execution.

Referring to FIG. 2, the recognition coverage function (200) provides a bounded mapping from nonnegative magnitude inputs (210) to coverage outputs (230) under a fixed constant X_opt (220). The boundedness behavior (240), monotonicity behavior (250), and saturation behavior (260) provide stability across small and large regimes. As a result, recognition-based scaling avoids unbounded growth in sizing parameters or scoring weights as dataset sizes and workload magnitudes increase. In embodiments supported by formal verification artifacts (270), the boundedness and monotonicity properties provide additional confidence in correctness of the stated scaling and scoring expressions.

Referring to FIG. 3, recognition-based sizing of a recognition B+ tree (300) produces an integer node capacity parameter (350) that can be applied directly within a tree-based index to influence fan-out and traversal behavior, with split/merge (rebalancing) logic (360) maintaining invariants under updates. Recognition-based node capacity determination can reduce unnecessary memory overhead and can improve index access locality for the evaluated workload regimes, while retaining the correctness properties of a B+ tree index.

Referring to FIG. 4, recognition-based sizing of a recognition hash table (400) produces an integer bucket count parameter (430) that can be applied to size a bucket array (420) of buckets (410). Incorporation of recognition coverage values into the recognition hash function (460), derived from a base hash function (440) and a nonnegative key magnitude (450), provides a bounded influence of key magnitude on bucket mapping. This can reduce collision-driven inefficiencies and improve utilization behavior without requiring manual selection of dataset-specific scaling parameters.

Referring to FIG. 5, recognition-based sizing of a recognition bloom filter (500) produces implementable parameters including a bit vector size M (520) and a hash count k (530) applied to a bit vector (510) using a hash function set (540) for insertion (550) and membership checks (560). Recognition-based sizing can reduce wasted memory or wasted I/O by maintaining a stable relationship between record count magnitudes and filter configuration while supporting a deployment-configurable false-positive target.

Referring to FIG. 7, recognition-based plan scoring and selection uses a plan score calculator (740) that combines inverse-cost desirability and feasibility under available resources. By mapping inverse cost and availability-to-requirement ratios through a bounded recognition coverage function and selecting via a path selector (750), plan selection remains stable across regimes and avoids domination by extreme magnitudes. This scoring approach supports improved plan selection under dynamic workload and resource conditions and can reduce tail latency caused by selecting plans that are low-cost in an abstract model but infeasible under current availability constraints.

Referring to FIG. 6, recognition-weighted resource allocation uses a resource allocator module (600) to distribute a resource budget (610) across concurrent tasks (620) using a demand estimator (630), a recognition-weighted allocation engine (640), and allocation outputs (650) applied by a scheduler/queue manager (660) with monitoring feedback (670). Because recognition weights are bounded and saturating, the allocation policy reduces the likelihood that one task monopolizes resources purely due to large demand magnitude, while still allocating proportionally more resources to higher-demand tasks. This can stabilize performance under contention and can reduce persistent hot-spot overload conditions.

Referring to FIG. 8, the end-to-end method flow (800) coordinates recognition-based operations across query receipt (810), parsing and analysis (820), feature computation (830), complexity scoring (840), recognition-based sizing (850), candidate plan generation (860), plan scoring and selection (870), resource allocation (880), execution (890), monitoring/adaptation (895), and results output (898). By explicitly coupling monitoring/adaptation to telemetry and to the same recognition-based primitives, the system supports continuous improvement under shifting workloads without requiring manual retuning of the constant X_opt or manual reconfiguration of multiple independent knobs.

Referring to FIG. 9, the invention is implementable as software executed by one or more processors (910) using memory (920) and interacting with DBMS software (960) via an RDSA instruction module (970). This supports deployment across a wide range of database systems and computing environments, including on-premise deployments, cloud deployments, and managed services. Telemetry/logging support via a telemetry/log store (980) supports monitoring and adaptation while preserving operational auditability.

Referring to FIG. 10, the invention supports distributed deployments in which a distributed database cluster (1000) includes a coordinator node (1010), database nodes (1020), shards/partitions (1030), replicas (1040), and a routing/query distribution module (1080) interconnected via a network fabric (1050). Per-node resource allocators (1060) and telemetry aggregation (1070) allow recognition-weighted allocation and recognition-informed routing decisions to be applied at scale. This supports reductions in cross-node fan-out, improved shard-level resource distribution, and improved tail latency behavior under multi-tenant and multi-region workloads.

Collectively, these features provide technical improvements to database query optimization and execution, including reduced average query time, reduced tail latency, improved resource utilization, reduced I/O amplification through prefiltering and partition pruning, and reduced manual tuning burden. These advantages are non-limiting and may vary depending on workload, dataset, and deployment configuration.

Referring to FIG. 2, in some embodiments one or more mathematical properties used by the recognition coverage function framework are supported by formal verification artifacts (270).

The formal verification artifacts (270) may include proof scripts, proof terms, proof objects, or other machine-checkable representations that are processed by an automated proof checker to confirm that stated properties follow from stated definitions under stated domain constraints. In representative embodiments, the formal verification artifacts (270) are produced and checked using the Lean 4 proof assistant, although any proof assistant capable of checking the stated properties may be used.

The formal verification artifacts (270) may be used to substantiate foundational properties of the recognition coverage function (200) and, where applicable, properties of expressions derived from the recognition coverage function that are used in sizing, scoring, and allocation. For example, the artifacts (270) may support one or more of: boundedness of the coverage output (230) such that 0<=F_cov(r, X_opt)<1 for all r>=0 and for fixed X_opt (220); monotonicity behavior (250) such that increasing r does not decrease F_cov(r, X_opt); and saturation behavior (260) such that the coverage output approaches an upper bound as r becomes large. The artifacts (270) may also support positivity and nonnegativity conditions used in implementation, such as demonstrating that sizing expressions remain nonnegative for valid domains and that allocation weights computed from recognition coverage values are nonnegative when demand magnitudes are nonnegative.

Referring to FIG. 1, these verified properties may correspond to safe and stable operation of the recognition coverage function engine (150) and the downstream subsystems that depend on it, including the recognition-optimized data structure manager (160), the execution engine (170), the resource allocator (180), and the adaptive optimizer (190). For example, boundedness and monotonicity help ensure that recognition-based sizing parameters used for structures and filters do not become negative, and that recognition-based scores and weights behave predictably as the underlying magnitudes change. In this manner, formal verification artifacts (270) provide supporting evidence that the mathematical primitives used by the system behave as described.

Formal verification is optional and is not required for implementation or operation of the disclosed invention. The database optimization and execution mechanisms described herein are implementable using conventional programming techniques and standard mathematical libraries.

The role of the formal verification artifacts (270) is to support the correctness of stated mathematical properties and to facilitate high-assurance reasoning about the boundedness and monotonicity properties that underlie sizing, scoring, and allocation computations. In some embodiments, a deployment may store or reference such artifacts as part of documentation, validation, or certification workflows, while runtime execution remains a standard software execution of the described computations.

Where a formal verification artifact (270) is used to substantiate a property, the property is understood to be verified under the specific definition of the recognition coverage function (200), the specific definition of the recognition constant X_opt (220), and the stated domain constraints for inputs and operations (for example, r>=0, cost>0, required >0, and 0<epsilon<1).

Implementations that deviate from the stated definitions or that violate the stated domain constraints are outside the scope of the verified guarantees, even if they remain within the scope of other embodiments described herein.

Referring to FIG. 9, the methods and systems described herein may be implemented on a computing system (900) that includes one or more processors (910), one or more memories (920), one or more storage devices (930), and one or more network interfaces (940) coupled via one or more buses or interconnects (950). The processor(s) (910) may include general-purpose processors, microprocessors, multi-core processors, or other instruction-processing units capable of executing software instructions. The memory (920) may include volatile memory and/or non-volatile memory used to store instructions and data during execution. The storage device(s) (930) may include persistent storage such as solid-state storage, magnetic storage, or other machine-readable storage used to store database content, index structures, telemetry, configuration, and results. The network interface(s) (940) may provide communication over one or more networks to client devices, application servers, other database nodes, and/or external services.

In one embodiment, DBMS software (960) executes on the processor(s) (910) and provides database management functionality for storing, indexing, and querying a database/dataset (198).

An RDSA instruction module (970) executes in association with the DBMS software (960) and implements one or more functions described herein, including query parsing and analysis, computation of recognition coverage values, computation of complexity scores, computation and application of recognition-based sizing parameters for one or more recognition-optimized structures, scoring and selection of candidate execution plans, recognition-weighted resource allocation, and monitoring-driven adaptation. The RDSA instruction module (970) may be implemented as one or more libraries, plugins, stored procedures, services, background tasks, or other executable components integrated with the DBMS software (960) or operating alongside it.

In some embodiments, the RDSA instruction module (970) operates as part of a query optimizer and planner; in other embodiments it operates as part of a scheduler or resource manager; and in other embodiments it spans multiple layers of the DBMS stack.

The computing system (900) may store telemetry, logs, statistics, and other operational records in a telemetry/log store (980). The telemetry/log store (980) may store query latency statistics, throughput statistics, queue depths, resource utilization metrics, cache hit rates, filter effectiveness metrics, index health metrics, partition hot-spot indicators, and other measurements used by the adaptive optimizer (190). Telemetry may be stored locally on the storage device(s) (930), and/or may be exported to external monitoring systems. In some embodiments, telemetry is sampled or aggregated over time windows, and adaptation decisions are triggered when thresholds are crossed, baseline bands are violated, trends persist over a configured window, or periodic cadence events occur.

In one embodiment, the computing system (900) stores, in memory (920) and/or storage (930), one or more data structures used by the RDSA logic. For example, storage may contain a recognition B+ tree index, a recognition hash table, a recognition bloom filter, and a multi-dimensional recognition array, each configured using recognition-based sizing parameters. The computing system (900) may also store one or more configuration inputs such as resource budgets, false-positive targets, service-level targets, and policy thresholds, which are used by the RDSA instruction module (970) when computing sizing, scoring, and allocation decisions.

Referring to FIG. 10, in a distributed embodiment the methods and systems described herein are implemented in a distributed database cluster (1000). The distributed database cluster (1000) includes a coordinator node (1010) and a plurality of database nodes (1020) interconnected via a network fabric (1050). Each database node (1020) may correspond to a computing system of the type described with respect to FIG. 9 and may execute DBMS software and RDSA logic. The database nodes (1020) store and serve shards/partitions (1030) of the database/dataset (198), and may maintain replicas (1040) for fault tolerance, geographic distribution, and/or read scaling.

Queries may be received at the coordinator node (1010) and routed to one or more database nodes (1020) according to a routing/query distribution module (1080). In some embodiments, the coordinator node (1010) also performs global plan selection, global scheduling, and coordination of distributed execution stages.

In one embodiment, each database node (1020) includes a per-node resource allocator (1060) that allocates node-local resources across shard-local tasks and concurrent queries. The per-node resource allocator (1060) may implement recognition-weighted allocation as described herein and may cooperate with a scheduler or queue manager to enforce allocation outputs. In some embodiments, the coordinator node (1010) computes higher-level distribution decisions, such as assigning subqueries to nodes or selecting degrees of parallelism, while the per-node resource allocators (1060) enforce local allocations to meet node-local constraints.

The distributed database cluster (1000) may include a telemetry aggregator (1070) that aggregates telemetry from database nodes (1020) and optionally from the coordinator node (1010). Aggregated telemetry may be used to support cluster-wide adaptive optimization decisions, including rebalancing of shards/partitions (1030), adjustment of replica placement (1040), adjustment of routing policies in the routing/query distribution module (1080), and triggering of maintenance actions such as resizing or rebuilding recognition-optimized structures across nodes. In one embodiment, cluster-level adaptation decisions are performed by an adaptive optimizer (190) operating at the coordinator level, while node-level adaptations are performed by node-local adaptive logic operating in association with node-local telemetry.

The invention may also be implemented as a non-transitory computer-readable medium embodiment. In such embodiments, instructions stored in one or more non-transitory computer-readable media, when executed by one or more processors (910), cause performance of one or more operations described herein. These operations may include receiving a query, computing recognition coverage values using a fixed constant, computing complexity scores, computing and applying recognition-based sizing parameters for one or more recognition-optimized data structures, generating and scoring candidate execution plans, selecting an execution plan, computing recognition-weighted resource allocations, executing the selected plan, monitoring telemetry, and performing adaptation actions based on monitored telemetry. The non-transitory computer-readable medium may include one or more of persistent storage devices, memory devices, or other machine-readable storage media, and may store executable program instructions, configuration parameters, and data structures used to implement the described functionality.

In these computing embodiments, the described recognition-based sizing, scoring, and allocation computations are performed by software executing on the processor(s) (910) and operating on data stored in memory (920) and storage (930), and the same functional logic may be deployed in single-node environments or distributed clusters. The computing boundaries described with respect to FIG. 9 and FIG. 10 provide implementable architecture support for method, system, and non-transitory computer-readable medium claims that recite execution of recognition-based database optimization operations by a processor using memory and interacting with database storage and networked components.

What is claimed is:

1. A computer-implemented method of executing a database query in a database management system, the method comprising:
receiving a query;
parsing the query to determine a set of query components;
computing, for each query component, a nonnegative feature magnitude;
computing a complexity score for the query by applying a bounded coverage function to the nonnegative feature magnitudes and combining resulting coverage values;
determining, based on the bounded coverage function, at least one configuration parameter for at least one database access structure selected from an index structure, a hash structure, and a probabilistic membership filter;
generating a plurality of candidate execution plans for the query;
for each candidate execution plan, computing a plan score that incorporates (i) a cost estimate for the candidate execution plan and (ii) a feasibility ratio derived from available computing resources and required computing resources;
selecting, using the plan scores, a selected execution plan from the plurality of candidate execution plans;
allocating computing resources among a plurality of tasks including a task corresponding to execution of the selected execution plan by computing allocation weights derived from the bounded coverage function and nonnegative demand magnitudes for the plurality of tasks;
executing the selected execution plan using the allocated computing resources and the at least one database access structure configured according to the at least one configuration parameter; and
outputting results of the query.

2. The method of claim 1, wherein the bounded coverage function is defined as F_cov(r, X_opt)=r/(r+X_opt) for r>=0, and wherein X_opt is a fixed positive constant.

3. The method of claim 1, wherein determining the at least one configuration parameter comprises determining a node capacity for a B+ tree index structure as NodeCapacity=ceil(F_cov(N, X_opt)*log 2(N)) for N>=2, where Nis a record count or a record count estimate.

4. The method of claim 1, wherein determining the at least one configuration parameter comprises determining a bucket count for a hash structure as BucketCount=ceil(N*F_cov(N, X_opt)) for N>=1, where Nis a record count or a record count estimate.

5. The method of claim 4, wherein the hash structure maps a key to a bucket index using h_rec (key)=(h0(key)*F_cov(len(key), X_opt)) mod BucketCount, where h0 is a base hash function and len (key) is a nonnegative key magnitude.

6. The method of claim 1, wherein determining the at least one configuration parameter comprises determining a bit vector size for the probabilistic membership filter as M=ceil(N*log 2(1/epsilon)*F_cov(N, X_opt)) for N>=1 and 0<epsilon<1.

7. The method of claim 6, further comprising determining a number of hash functions for the probabilistic membership filter as k=ceil(log 2(1/epsilon)*F_cov(log 2(1/epsilon), X_opt)).

8. The method of claim 1, wherein computing the complexity score comprises computing ComplexityScore (Q)=prod_{i=1 . . . n} F_cov(q_i, X_opt), where each q_i is one of the nonnegative feature magnitudes.

9. The method of claim 1, wherein computing the plan score comprises computing Score=F_cov(1/cost, X_opt)*F_cov(available/required, X_opt), where cost >0, required >0, and available >=0.

10. The method of claim 1, wherein allocating computing resources comprises computing Allocation(i)=R*F_cov(demand_i, X_opt)/sum_j F_cov(demand_j, X_opt), where each demand_i is one of the nonnegative demand magnitudes, R is a total resource budget, and the denominator is greater than zero.

11. The method of claim 1, further comprising maintaining recognition-optimized multi-scale data partitioning by selecting, splitting, merging, or relocating data partitions based on coverage values computed from nonnegative partition magnitudes using the bounded coverage function, wherein maintaining the recognition-optimized multi-scale data partitioning mitigates hot-spot partitions or reduces cross-node fan-out in a distributed deployment.

12. The method of claim 1, further comprising monitoring runtime telemetry during execution of the selected execution plan and, based on the runtime telemetry, updating at least one of (i) the at least one configuration parameter, or (ii) allocation of computing resources among the plurality of tasks, wherein the runtime telemetry comprises at least two telemetry magnitudes selected from: a queue backlog magnitude, an input/output backlog magnitude, a processor utilization magnitude, and a memory pressure magnitude.

13. The method of claim 1, further comprising using a multi-dimensional recognition array to constrain at least one of candidate execution plan generation and execution of the selected execution plan, the multi-dimensional recognition array storing identifiers of candidate storage regions associated with multi-attribute query constraints.

14. The method of claim 13, wherein the multi-dimensional recognition array is maintained by computing region sizing, region splitting, or region merging decisions using coverage values computed from nonnegative region magnitudes using the bounded coverage function.

15. The method of claim 1, further comprising monitoring runtime telemetry during execution of the selected execution plan and, based on the runtime telemetry, updating at least one of (i) the at least one configuration parameter, (ii) a partitioning configuration, (iii) selection among candidate execution plans for subsequent queries, or (iv) allocation of computing resources among the plurality of tasks.

16. The method of claim 1, wherein computing, for each query component, the nonnegative feature magnitude comprises computing at least two magnitudes selected from: a join count magnitude, a predicate count magnitude, an aggregation indicator magnitude, a grouping-key count magnitude, and an estimated cardinality magnitude.

17. A database system, comprising:
one or more processors;
memory storing instructions that, when executed by the one or more processors, cause the database system to:
receive a query and generate a plurality of candidate execution plans for the query;
compute a complexity score for the query by applying a bounded coverage function to nonnegative query feature magnitudes derived from the query;
compute, using the bounded coverage function, at least one configuration parameter for at least one database access structure;
compute, for each candidate execution plan, a plan score incorporating a cost estimate and a feasibility ratio derived from available computing resources and required computing resources;
select, using the plan scores, a selected execution plan;
allocate computing resources among a plurality of tasks by computing allocation weights derived from the bounded coverage function and nonnegative demand magnitudes; and
execute the selected execution plan using the allocated computing resources to output results of the query.

18. The database system of claim 17, wherein the at least one database access structure comprises at least one of: a recognition B+ tree index structure having a node capacity computed using the bounded coverage function, a recognition hash structure having a bucket count computed using the bounded coverage function, and a recognition probabilistic membership filter having a bit vector size computed using the bounded coverage function.

19. The method of claim 15, wherein updating is triggered when a monitored metric exceeds a target for at least a persistence window comprising a plurality of monitoring intervals.

20. A non-transitory computer-readable medium storing instructions that, when executed by one or more processors of a database system, cause the database system to perform the method of claim 1.
